(19) United States
(12) Patent Application Publication
(10) Pub. No.: US 2007/0147236 A1
(43) Pub. Date: Jun. 28, 2007

(54) Method of detecting and avoiding interference among wireless network by dynamically estimating the noise level from the UWB PER and BER, and synchronously switching into unoccupied channel

(76) Inventor: Hyun Lee, Ladera Ranch, CA (US)

Correspondence Address: Hyun Lee, 21 Thalia St., Ladera Ranch, CA, 92694, US

(21) Appl. No.: 11/585,576

(22) Filed: Oct. 24, 2006

Related U.S. Application Data
(60) Provisional application No. 60/753,753, filed on Dec. 22, 2005.

(51) Int. Cl. H04L 12/26; H04Q 7/00

(52) U.S. Cl. 370/229; 370/329

(57) ABSTRACT

A way of implementing the Detect-and-Avoid (DAA) function into WiMedia/UWB devices based on the existing WiMedia protocol. The DAA operation is conducted in the MAC, and the MAC informs the software for the decision making process.

The DAA operation in this invention composed of two individual operations; the Interferer-Detection operation and the Avoid-Interference operation.

The Avoid-Interference operation follows the Interferer-Detection operation if the host MAC reports excessive error after the Interferer-Detection operation.

This invention suggests various ways of avoiding interferences with the existing services or with other UWB network

### RELATED APPLICATIONS

The present application is a continuation application of United States provisional patent application, serial number U.S. 60/753,753, filed Dec. 22, 2005, for METHOD OF DETECTING AND AVOIDING INTERFERENCE AMONG WIRELESS NETWORK BY DYNAMICALLY ESTIMATING THE NOISE LEVEL FROM THE UWB PER AND BER, AND SYNCHRONOUSLY SWITCHING INTO UNOCCUPIED CHANNEL, by Hyun Lee, included by reference herein and for which benefit of the priority date is hereby claimed.

### FIELD OF THE INVENTION

The present invention generally relates to the fields of home and personal wireless networking and, more particularly, to Wireless Home Area Networks or Wireless Personal Area Networks that are based on various standard communication protocols.

### BACKGROUND OF THE INVENTION

More than one communication network, whose signals are modulated with various methods, likely occupy a wireless communication space. Therefore, the interferences between these networks dictate the QoS of these networks. In development of the UWB (WiMedia) technology, the noise level simulation for the QoS study was based on the AWGN, and the transmit power and the receive sensitivity were controlled to preserve a certain level of QoS (8% packet-drop-rate with 1024 byte data). However, there was no attempt to ensure the interference it causes to the existing services by preserving its own QoS. This missing specification in UWB protocol that ensures the co-existence with existing services brought concerns to MIC (Japan) and CEPT (Europe), and they mandated the DAA requirement that must be met by any devices that are based on the UWB technology.

Since the existing services may not use the same modulation scheme and protocol as the UWB protocol, it becomes real a challenge for the UWB manufactures to satisfy the DAA requirement. For example, since a UWB antenna cannot detect the narrowband signals of the existing services, the problem the UWB manufactures face is a much more fundamental issue, such as how to detect the existing service signals. A number of PHY companies put their effort on resolving this DAA issue, however, no PHY company had developed a working solution yet.

The general solution that suggested by the PHY companies is;

Multiple Physical layer Solution, for example, “Detect and Avoid Technology For Ultra Wideband (UWB) Spectrum Usage”—a white paper—Wisair Corporate.

This solution requires multiple physical, one for the UWB operation and the others for detecting the narrowband and/or broadband signals.

The idea is to use the narrowband or broadband antenna to detect the existing signals while using the ultra-wideband antenna for the UWB communication. The narrowband and/or broadband signal detection generally occurs during the quiet time of the UWB signal since the USB signal strength (˜−40 DBM) could be stronger than the signal strength of the existing signals, which could be less than −60 DBM. In some cases, when the existing signal strength is stronger than the UWB signal strength, the existing signals can be detected during the active UWB signal transmission. However, if the existing signal strength is stronger than the UWB signal, since the receiver can filter out the UWB signal, there is actually no need for the DAA operation. Therefore, the multiple-antenna solution is most effective in detecting the existing signal during the quiet period of the UWB signal.

In addition to the limited usage, another shortcoming of this solution is from its requirement of holding any UWB traffic while detecting the existing services. This method may require a large number of antennas to parallelize the detecting effort. For example, to be able to detect the existing signal with one antenna, it would require 384 msec of UWB quite time, which can be many seconds of real time. This quiet time requirement is computed with the fact that it requires 1 msec of signal power integration time to make the correct decision on whether the broadband signal is the existing signal or noise.

Thus, the total quiet time to determine the existing signal would be:

1 msec (integration time)×128 (sub-carriers/UWB-frequency-band)×3 (bands/band-group-for OFDM)=384 msec.

This detection time would be long enough to cause the existing signal to loose its connection.

It is therefore an object of the invention to allow the UWB network to detect the existing service without additional narrowband/broadband antenna.

It is another object of the invention to remove the requirement of having the PHY baseband processors to recognize the narrowband/broadband signals.

It is another object of the invention to see the benefit even if this invention were implemented in only a limited number of devices (or one device) in the system.

It is another object of the invention to allow detecting the existing services without integrating the RF power in each sub-carrier over 1 msec period, thus, significantly reducing the detection time.

It is another object of the invention to allow this narrowband/broadband detection method to be applicable to any other wireless communication network in addition to the network using UWB.

It is another object of the invention to allow the interference detection mechanism to be applicable to any communication protocol that uses UWB channel.

It is another object of the invention to find the appropriate interference interferences avoidance procedure based on the results of the interference analysis.

It is another object of the invention to minimize the duration of interfering the existing services.

It is another object of the invention to resolve the interference issue with the minimum down time (quiet time) for the UWB network

It is another object of the invention to effectively mitigate the interferences among a number of UWB networks whose physical spaces are overlapping each other.

### SUMMARY OF THE INVENTION

In accordance with the present invention, there is provided a way of implementing the Detect-and-Avoid (DAA) function into WiMedia/UWB devices based on the existing WiMedia protocol. The DAA operation is conducted in the MAC, and the MAC informs the software for the decision making process.

The DAA operation in this invention composed of two individual operations; the Interferer-Detection operation and the Avoid-Interference operation.

The Avoid-Interference operation follows the Interferer-Detection operation if the host MAC reports excessive error after the Interferer-Detection operation.

This invention suggests various ways of avoiding interferences with the existing services or with other UWB network

### BRIEF DESCRIPTION OF THE DRAWINGS

A complete understanding of the present invention may be obtained by reference to the accompanying drawings, when considered in conjunction with the subsequent, detailed description, in which:

FIG. 1 is the impact of narrow band existing signal on the bit error rate (ber) as function of signal to interferer ratio (sir);

FIG. 2 is the impact of narrow band existing signal on the average bit error rate (ber) as a function of average white gaussian noise (awgn) for different levels of sir;

FIG. 3 is a block diagram of the encoding process for the payload in a uwb packet;

FIG. 4 is a set of reverse equations of the 3 stage interleaver for the symbol generation; and

FIG. 5 is a state diagram showing the daa process.

For purposes of clarity and brevity, like elements and components will bear the same designations and numbering throughout the Figures.

### DESCRIPTION OF THE PREFERRED EMBODIMENT

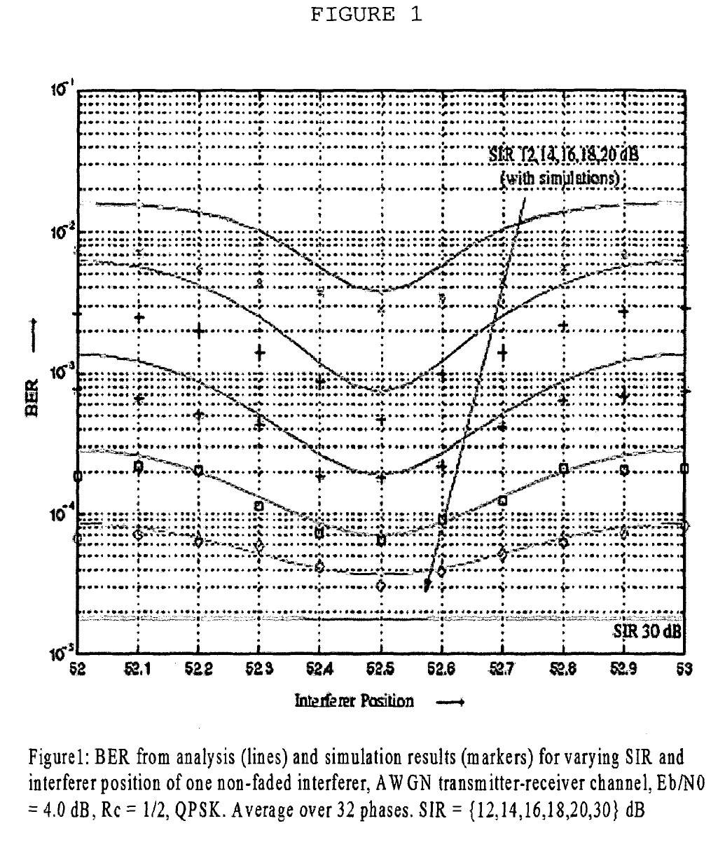

FIG. 1 is the impact of narrow band existing signal on the bit error rate (ber) as function of signal to interferer ratio (sir).

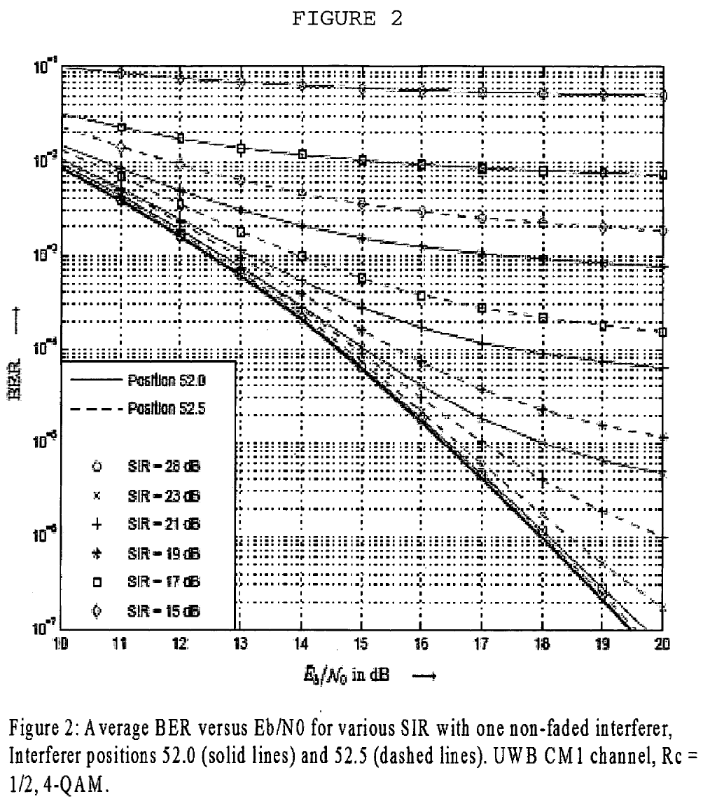

FIG. 2 is the impact of narrow band existing signal on the average bit error rate (ber) as a function of average white gaussian noise (AWGN) for different levels of sir.

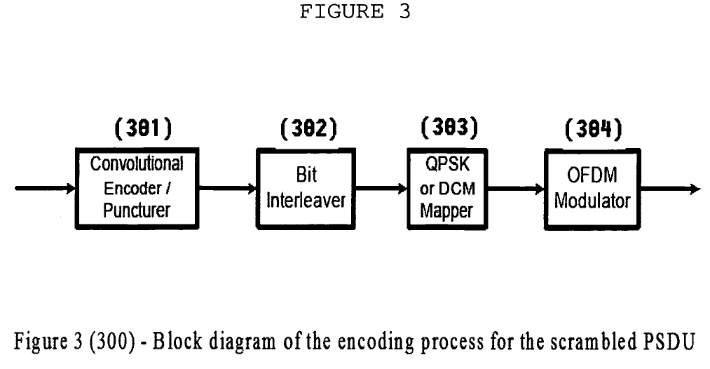

FIG. 3 is a block diagram of the encoding process for the payload in a UWB packet.

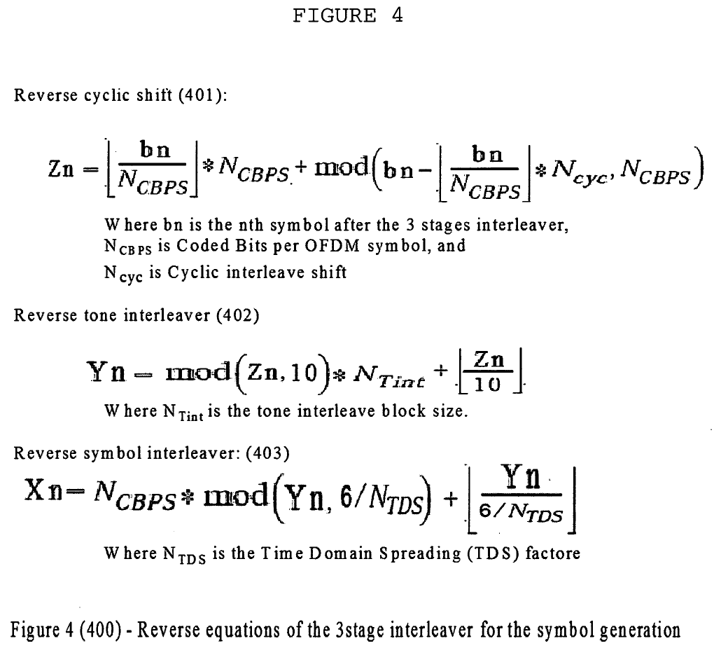

FIG. 4 is a reverse equation of the 3 stage interleave for the symbol generation.

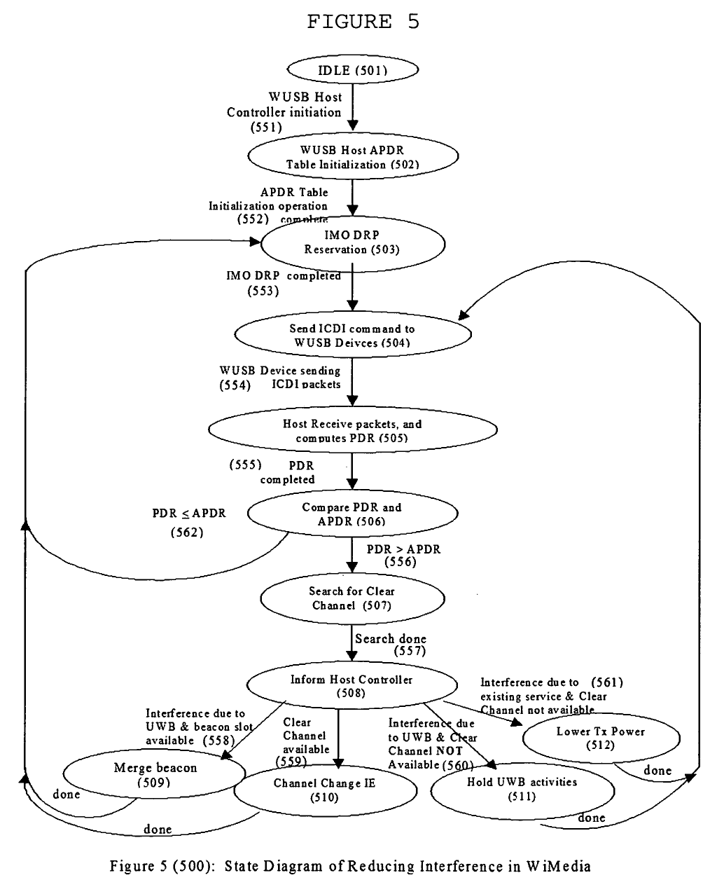

FIG. 5 is a state diagram showing the DAA process.

The Detect-and-Avoid (DAA) process is based on the existing WiMedia protocol. The real time DAA operation is conducted in the host MAC, and the host MAC informs the software for the decision making process.

In the FIG. 5, the WUSB Host is a WUSB Host Wire Adaptor (HWA). However, in general, it can be any device that performs the host or the master role in a network. A Beacon-master in UWB network or a master in the Bluetooth, or a access point device in a Pico net can be a host, and the states and the transitions in FIG. 5 applies to all the network types regardless of the network type. The WUSB Device in FIG. 5 is a WUSB Device Wire Adaptor (DWA). However, in general, it can be any device that performs the peripheral or the slave role in a network. A peripheral or slave device receives instructions from the host or master, and executes these instructions.

The DAA operation steps are:

1) The Software programs a MAC register with the Average-Packet-Drop-Rate (APDR) of the received packets from specific devices based on the AWGN study and the range check results

2) The MAC requests one of these devices to send packets during a reserved DRP period for the DAA operation. The packet size, the communication channel, and the transmit power level are dictated by the requesting MAC such that any interference can directly be observed by the increasing PDR compared with the APDR when the environment contains only AWGN. The MAC conducts this operation on all channels (including the channel that the MAC is currently using for the normal operation), and stores the PDR information into the Channel-PDR register, which contains the PDR for each channel.

3) The MAC also monitors the OFDM signal activities during the Clear Channel Assessment (CCA) time or during the unreserved time slot periods to decide whether the increasing PDR is due to any interference from other UWB networks. The MAC conducts this monitoring operation on all channels (including the channel that the MAC is currently using for the normal operation), and stores the information that indicates which channel has no activities into the Clear-Channel register.

4) If the MAC sees UWB signals, during the CCA period, on the channel that the MAC is currently using for the normal operation, the MAC decides that the excessive PDR is due to the interference with another UWB, and reports to the upper layer controller. The upper layer controller takes one of two actions, merge its beacon with the other network, or move its network to another channel. If the controllers decided to move to another channel, it reads the Clear-Channel register and the Channel-PDR register to decide which channel is unoccupied by another UWB network and by an existing service.

5) If the MAC does not detects any UWB signals in step 3, the MAC recognizes that it is causing interference to the existing service, it reports to the upper layer controller. The upper layer controller must move the network to unoccupied channel by reading the Clear-Channel and the Channel-PDR registers.

In Step 1, the upper layer controller informs the MAC on the source device distance, which translates to the APDR in the AWGN environment.

In Step 2, the transmit power and the packet size are determined by the distance from the source. The transmit power is set such that the receive sensitivity is comparable with the signal strength of the existing service that the MAC needs to detect. The packet size is set such that a slight increase of bit error rate, due to the interference from any existing channel, directly translates to substantial increase in the PDR.

In Step 3 and Step 4, the MAC actively seeks interference with 2 methods. The MAC checks to see if the channel is occupied by other UWB signals with the CCA command. The MAC also draws a decision about the presence of an existing service by monitoring the change of the PDR.

FIG. 1 and FIG. 2 show the change of BER vs. the signal strength of the existing service (noted as the Interferer in these figures). The software uses this information and the data patterns of the specific packets to identify the sub-carrier that are also occupied by the existing services. The software may simultaneously identify a number of the existing services by changing the number of these specific packets along with the data pattern of each packet.

FIG. 1 shows the impact of a narrowband signal on the UWB signal Bit Error Rate (BER) vs. the Signal to Interference ratio (SIR) with average-signal-to-AWGN (E/N)=4 db. The error rate is computed with sweeping the position of the narrowband signal from one sub-carrier to the next sub-carrier. As expected, when the narrowband signal completely occupies one sub-carrier, the error rate more than doubles the error rate when the narrowband occupies part of each sub-carrier.

The set up for this analysis is for CM1 (short range line-of-sight channel), and the SIR ratio is the average over all the sub-carriers. For example, in 384 sub-carriers case with one interferer that is directly impacting just one sub-carrier, the SIR of the impacted sub-carrier would be;

10*log(384)=˜26 dB lower than the average SIR since the interferences on all other sub-carriers are zero).

E is the average signal strength, and Rc is the effective code rate after puncturing and repetition.

FIG. 2 shows the average BER vs. E/N for various SIR with one non-faded interferer.

FIG. 3 shows the block diagram of the encoding process for the scrambled PSDU

In step 2, the software also can request one of the specific devices to send a packet with payload patterns to help isolated the sub-carriers that are impacted by the existing services. In this case, the software may pre-program the packet with the payload that may not contain any meaningful information, but it would help the receiver to directly observe interference. These type of packets would provide enough information to the software for identifying the sub-carriers that are impacted by the existing services.

FIG. 4 shows the mathematical equations that represent the reverse encoding process in FIG. 3. These equations in FIG. 4 may be used to construct the payload patterns that would help to the software to isolate the sub-carriers that are also occupied by the existing services.

FIG. 5 shows the state diagram of an implementation example of this invention.

For the DAA operation, this invention may need a transmit control packet that the host would need to send out to the target device to control the transmit parameters. For the WUSB case, the protocol already includes a general transmit control packet

The WUSB Host controller (software) initiates (502) the range check to all WUSB Devices, and stores this information into the MAC along with the Average Packet Drop Rate (ADPR). The APDR table contains the average packet drop rate verses the packet size and the transmit power level for the given distance (or range).

After the APDR information is ready, the WUSB Host MAC reserves DRP (503) for the Interference Mitigation Operation (IMO). The WUSB Host MAC, without the upper layer controller instruction, sends Interference Check Data In (ICDI) command to the WUSB Devices (504). The ICDI command is a Data In command

with a specific In target device. The WUSB Device receiving the ICDI command, it sends the packet to the WUSB Host (505) with the size and the transmit power level dictated by the WUSB Host. The WUSB Device also sends these packets on the channel that the Host requested, without the “Channel Change IE 510”. The transmit channel, power level, and the packet size information is in the ICDI command packet payload, and the MAC recognizes this packet since the In End Point is in the WUSB Device MAC.

As the WUSB Host MAC receives these ICDI in packets from the WUSB device, it compares the Packet Drop Rate (PDR) with the ADPR (506). If the PDR is similar with ADPR, the MAC does not take any action until the next IMO DRP time slot.

However, the WUSB Host MAC detects excessive PDR comparing with ADPR, the WUSB Host MAC starts searching for a clear UWB channel by comparing PDR with ADPR (507). Once the clear UWB channel search is done, the UWB Host MAC informs the WUSB controller (508) about the interference problem in the current channel. The clear UWB channel search completes with either finding all available UWB channels or not finding any available UWB channel. In either case, the WUSB MAC stores this information into the

When the WUSB controller receives the interference problem information (508), the controller reads the Clear-Channel and Channel-PDR registers determining if the excessive PDR is due to interference from another UWB, or due to the existing service.

If the interference is from another UWB, the WUSB Host removes the interference either by merging its beacon (509) with the other UWB network, or by executing the “Channel Change” IE (510) to move to un-interfering channel if it cannot merge the beacon. After completion of the interface removing process, it repeats the IMO operation.

If the interference is with another UWB, and if there is no other Clear Channel, then the WUSB Host may shut down the network activities (511) until it finds a Clear Channel.

If the interference is from an existing service, the WUSB Host removes the interference by moving to another channel (510) based on the Clear-Channel information. If there is no clear channel, the WUSB Host may lower the transmit power (512) of all sub-carriers in the channel. The WUSB Host also may lower the Transmit power (512) of selected sub-carriers if it had identified the sub-carriers that are also occupied by the existing services.

While the WUSB Host shut down the network activity, the designated WUSB device continuously sends the packets according to the latest ICDI command, and the WUSB Host MAC also continuously analyze the ICDI data-in packets. Once the WUSB Host MAC identifies a clear channel, it reserves that channel (509) by starting the beacon period, and notifies the WUSB Host Controller (510) for it to establish a WUSB network in that channel. After it notifies the controller, it repeats the IMO operation.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method of detecting and avoiding interference among wireless network by dynamically estimating the noise level from the uwb per and ber, and synchronously switching into unoccupied channel for implementing software assisted the detect-and-avoid (daa) mechanism, comprising:
means for constructing a set of equations that would produce the original data patterns, which would produce different error patterns depending on which ofdm sub-carriers are also occupied by the existing services;
means for resetting the system into the known state, where all host (network controller, arbiter) and all peripheral (all device that are not controller or arbiter) in the network should be ready for the daa operation;
means for creating a table (in the host mac) that would hold the predicted average-packet-drop-rate (apdr) of received packets from each peripheral based on the distance, packet size, data rate, and transmit power under average white gaussian noise (awgn) environment;
means for the host mac reserving additional time slots (drp) for the interference mitigation (a.k.a. daa) operation, and, during this time slot, the host requesting the devices to send specific packets with specific payload data patterns that would produce different error patterns depending on which ofdm sub-carriers are also occupied by the existing services;
means for the host sending the interference-check-data-in (icdi) command, which contains transmit control parameters and the specifics of the packets to be transmitted, to the target peripheral device;
means for the host computing the packet drop rate (pdr) of the received packet from the peripherals;
means for the host continuously checking if the pdr is greater than the predicted apdr. the host stays in this state as long as the actual pdr is lower than apdr;
means for the host to decide if the pdr is greater than the predicted apdr. if the pdr is greater than apdr, the host searches for a clear channel by listening to other channels for any signal activities;
means for the host (network controller) starts daa analysis based on the error information and the clear channel accessment (cca) results from the host mac;
means for merging the beacon when interference is with other uwb network and there are open time slots in the other uwb network;
means for moving to another channel when the interferer is another uwb network and there are no open time slots in the interfering uwb network, but there is a clear channel;
means for the host halting all uwb activities when the host can not merge with the interfering uwb network and the host also cannot find a clear channel;
means for lowering the transmission power (of the whole channel or selected sub-carriers) below the signal strength of the existing service when the uwb network is interfering with the existing services and the host cannot find a clear channel;
means for initiating the daa operation after configuring the host (controller, arbiter) and the peripheral (other than the controller or arbiter) in the network;
means for the host informing the software when apdr table construction has been completed for the daa operation;
means for the host informing the software that it has reserved time slots for the daa operation;
means for the specific peripheral device sending specific packets to the host for the daa operation;
means for notifying the software that the actual packet drop rate (pdr) computation has been accumulated;
means for recognizing that the actual packet drop rate (pdr) is greater than the predicted average packet drop rate (apdr);
means for indicating that the software has completed the interference-detection operation by identifying the sources of the interferences, and the host is ready for the interference-avoidance operation by completing the clear channel assessment (cca) task;
means for indicating that there are adequate amount of available time slots in the interfering uwb network for the purpose of merging with the interfering network;
means for indicating that there is at least one unoccupied communication channel which the network can utilize to stop interfering with other networks;
means for indicating that the amount of available time slots in the interfering uwb network is inadequate to merge the network, and there is no unoccupied communication channel for the network to utilize for the purpose of stopping the interference with other uwb networks;
means for indicating that the network is interfering with the existing service, and there is no unoccupied communication channel for the network to utilize for the purpose of stopping the interference with the existing services; and
means for indicating that the packet drop rate (pdr) is less than the predicted average packet drop rate (apdr), and the network restarts the daa operation.

2. The method of detecting and avoiding interference among wireless network by dynamically estimating the noise level from the uwb per and ber, and synchronously switching into unoccupied channel in accordance with claim 1, wherein said means for constructing a set of equations that would produce the original data patterns, which would produce different error patterns depending on which ofdm sub-carriers are also occupied by the existing services comprises a reverse equation of the 3stage interleaver to produce particular data patterns.

3. The method of detecting and avoiding interference among wireless network by dynamically estimating the noise level from the uwb per and ber, and synchronously switching into unoccupied channel in accordance with claim 1, wherein said means for resetting the system into the known state, where all host (network controller, arbiter) and all peripheral (all device that are not controller or arbiter) in the network should be ready for the daa operation comprises an initial state, idle.

4. The method of detecting and avoiding interference among wireless network by dynamically estimating the noise level from the uwb per and ber, and synchronously switching into unoccupied channel in accordance with claim 1, wherein said means for creating a table (in the host mac) that would hold the predicted average-packet-drop-rate (apdr) of received packets from each peripheral based on the distance, packet size, data rate, and transmit power under average white gaussian noise (awgn) environment comprises a state, wusb host apdr table initialization.

5. The method of detecting and avoiding interference among wireless network by dynamically estimating the noise level from the uwb per and ber, and synchronously switching into unoccupied channel in accordance with claim 1, wherein said means for the host mac reserving additional time slots (drp) for the interference mitigation (a.k.a. daa) operation, and, during this time slot, the host requesting the devices to send specific packets with specific payload data patterns that would produce different error patterns depending on which ofdm sub-carriers are also occupied by the existing services comprises an operation, imo drp reservation.

6. The method of detecting and avoiding interference among wireless network by dynamically estimating the noise level from the uwb per and ber, and synchronously switching into unoccupied channel in accordance with claim 1, wherein said means for the host sending the interference-check-data-in (icdi) command, which contains transmit control parameters and the specifics of the packets to be transmitted, to the target peripheral device comprises an operation, send icdi command to wusb device.

7. The method of detecting and avoiding interference among wireless network by dynamically estimating the noise level from the uwb per and ber, and synchronously switching into unoccupied channel in accordance with claim 1, wherein said means for the host computing the packet drop rate (pdr) of the received packet from the peripherals comprises an operation, host receive packets and compute pdr.

8. The method of detecting and avoiding interference among wireless network by dynamically estimating the noise level from the uwb per and ber, and synchronously switching into unoccupied channel in accordance with claim 1, wherein said means for the host continuously checking if the pdr is greater than the predicted apdr. the host stays in this state as long as the actual pdr is lower than apdr comprises an operation, compare pdr with apdr.

9. The method of detecting and avoiding interference among wireless network by dynamically estimating the noise level from the uwb per and ber, and synchronously switching into unoccupied channel in accordance with claim 1, wherein said means for the host to decide if the pdr is greater than the predicted apdr. if the pdr is greater than apdr, the host searches for a clear channel by listening to other channels for any signal activities comprises an operation, search for clear channel.

10. The method of detecting and avoiding interference among wireless network by dynamically estimating the noise level from the uwb per and ber, and synchronously switching into unoccupied channel in accordance with claim 1, wherein said means for the host (network controller) starts daa analysis based on the error information and the clear channel accessment (cca) results from the host mac comprises an operation, inform host controller.

11. The method of detecting and avoiding interference among wireless network by dynamically estimating the noise level from the uwb per and ber, and synchronously switching into unoccupied channel in accordance with claim 1, wherein said means for merging the beacon when interference is with other uwb network and there are open time slots in the other uwb network comprises an operation, merge beacon.

12. The method of detecting and avoiding interference among wireless network by dynamically estimating the noise level from the uwb per and ber, and synchronously switching into unoccupied channel in accordance with claim 1, wherein said means for moving to another channel when the interferer is another uwb network and there are no open time slots in the interfering uwb network, but there is a clear channel comprises an operation, channel change ie.

13. The method of detecting and avoiding interference among wireless network by dynamically estimating the noise level from the uwb per and ber, and synchronously switching into unoccupied channel in accordance with claim 1, wherein said means for the host halting all uwb activities when the host can not merge with the interfering uwb network and the host also cannot find a clear channel comprises a state, hold uwb activities.

14. The method of detecting and avoiding interference among wireless network by dynamically estimating the noise level from the uwb per and ber, and synchronously switching into unoccupied channel in accordance with claim 1, wherein said means for lowering the transmission power (of the whole channel or selected sub-carriers) below the signal strength of the existing service when the uwb network is interfering with the existing services and the host cannot find a clear channel comprises an operation, lower tx power.

15. The method of detecting and avoiding interference among wireless network by dynamically estimating the noise level from the uwb per and ber, and synchronously switching into unoccupied channel in accordance with claim 1, wherein said means for initiating the daa operation after configuring the host (controller, arbiter) and the peripheral (other than the controller or arbiter) in the network comprises a daa operation starting point, (wusb) host controller initiation.

16. The method of detecting and avoiding interference among wireless network by dynamically estimating the noise level from the uwb per and ber, and synchronously switching into unoccupied channel in accordance with claim 1, wherein said means for the specific peripheral device sending specific packets to the host for the daa operation comprises an operation, (wusb) device sending icdi packets.

17. The method of detecting and avoiding interference among wireless network by dynamically estimating the noise level from the uwb per and ber, and synchronously switching into unoccupied channel in accordance with claim 1, wherein said means for notifying the software that the actual packet drop rate (pdr) computation has been accumulated comprises software interrupt point, pdr completed.

18. The method of detecting and avoiding interference among wireless network by dynamically estimating the noise level from the uwb per and ber, and synchronously switching into unoccupied channel in accordance with claim 1, wherein said means for recognizing that the actual packet drop rate (pdr) is greater than the predicted average packet drop rate (apdr) comprises a decision point, pdr>apdr.

19. The method of detecting and avoiding interference among wireless network by dynamically estimating the noise level from the uwb per and ber, and synchronously switching into unoccupied channel in accordance with claim 1, wherein said means for indicating that the software has completed the interference-detection operation by identifying the sources of the interferences, and the host is ready for the interference-avoidance operation by completing the clear channel assessment (cca) task comprises an event completion point, search done.

20. The method of detecting and avoiding interference among wireless network by dynamically estimating the noise level from the uwb per and ber, and synchronously switching into unoccupied channel in accordance with claim 1, wherein said means for indicating that the amount of available time slots in the interfering uwb network is inadequate to merge the network, and there is no unoccupied communication channel for the network to utilize for the purpose of stopping the interference with other uwb networks comprises a decision point, uwb interference and no clear channel.

21. The method of detecting and avoiding interference among wireless network by dynamically estimating the noise level from the uwb per and ber, and synchronously switching into unoccupied channel in accordance with claim 1, wherein said means for indicating that the network is interfering with the existing service, and there is no unoccupied communication channel for the network to utilize for the purpose of stopping the interference with the existing services comprises a decision point, interfering with the existing services and clear channel not available.

22. The method of detecting and avoiding interference among wireless network by dynamically estimating the noise level from the uwb per and ber, and synchronously switching into unoccupied channel in accordance with claim 1, wherein said means for indicating that the packet drop rate (pdr) is less than the predicted average packet drop rate (apdr), and the network restarts the daa operation comprises a decision point, pdr<apdr.

23. A method of detecting and avoiding interference among wireless network by dynamically estimating the noise level from the uwb per and ber, and synchronously switching into unoccupied channel for implementing software assisted the detect-and-avoid (daa) mechanism, comprising:
a reverse equation of the 3 stage interleaver to produce particular data patterns, for constructing a set of equations that would produce the original data patterns, which would produce different error patterns depending on which ofdm sub-carriers are also occupied by the existing services;
an initial state, idle, for resetting the system into the known state, where all host (network controller, arbiter) and all peripheral (all device that are not controller or arbiter) in the network should be ready for the daa operation;
a state, wusb host apdr table initialization, for creating a table (in the host mac) that would hold the predicted average-packet-drop-rate (apdr) of received packets from each peripheral based on the distance, packet size, data rate, and transmit power under average white gaussian noise (awgn) environment;
an operation, imo drp reservation, for the host mac reserving additional time slots (drp) for the interference mitigation (a.k.a. daa) operation, and, during this time slot, the host requesting the devices to send specific packets with specific payload data patterns that would produce different error patterns depending on which ofdm sub-carriers are also occupied by the existing services;
an operation, send icdi command to wusb device, for the host sending the interference-check-data-in (icdi) command, which contains transmit control parameters and the specifics of the packets to be transmitted, to the target peripheral device;
an operation, host receive packets and comput pdr, for the host computing the packet drop rate (pdr) of the received packet from the peripherals;
an operation, compare pdr with apdr, for the host continuously checking if the pdr is greater than the predicted apdr. the host stays in this state as long as the actual pdr is lower than apdr;
an operation, search for clear channel, for the host to decide if the pdr is greater than the predicted apdr. if the pdr is greater than apdr, the host searches for a clear channel by listening to other channels for any signal activities;
an operation, inform host controller, for the host (network controller) starts daa analysis based on the error information and the clear channel accessment (cca) results from the host mac;
an operation, merge beacon, for merging the beacon when interference is with other uwb network and there are open time slots in the other uwb network;
an operation, channel change ie, for moving to another channel when the interferer is another uwb network and there are no open time slots in the interfering uwb network, but there is a clear channel;
a state, hold uwb activities, for the host halting all uwb activities when the host can not merge with the interfering uwb network and the host also cannot find a clear channel;
an operation, lower tx power, for lowering the transmission power (of the whole channel or selected sub-carriers) below the signal strength of the existing service when the uwb network is interfering with the existing services and the host cannot find a clear channel;
a daa operation starting point, (wusb) host controller initiation, for initiating the daa operation after configuring the host (controller, arbiter) and the peripheral (other than the controller or arbiter) in the network;
software interrupt point, apdr table initialization complete, for the host informing the software when apdr table construction has been completed for the daa operation;
software interrupt point, imo drp completed, for the host informing the software that it has reserved time slots for the daa operation;
an operation, (wusb) device sending icdi packets, for the specific peripheral device sending specific packets to the host for the daa operation;
software interrupt point, pdr completed, for notifying the software that the actual packet drop rate (pdr) computation has been accumulated;
a decision point, pdr>apdr, for recognizing that the actual packet drop rate (pdr) is greater than the predicted average packet drop rate (apdr);
an event completion point, search done, for indicating that the software has completed the interference-detection operation by identifying the sources of the interferences, and the host is ready for the interference-avoidance operation by completing the clear channel assessment (cca) task;
a decision point, uwb interference & beacon slot available, for indicating that there are adequate amount of available time slots in the interfering uwb network for the purpose of merging with the interfering network;
a decision point, clear channel available, for indicating that there is at least one unoccupied communication channel which the network can utilize to stop interfering with other networks;
a decision point, uwb interference and no clear channel, for indicating that the amount of available time slots in the interfering uwb network is inadequate to merge the network, and there is no unoccupied communication channel for the network to utilize for the purpose of stopping the interference with other uwb networks;
a decision point, interfering with the existing services and clear channel not available, for indicating that the network is interfering with the existing service, and there is no unoccupied communication channel for the network to utilize for the purpose of stopping the interference with the existing services; and
a decision point, pdr<apdr, for indicating that the packet drop rate (pdr) is less than the predicted average packet drop rate (apdr), and the network restarts the daa operation.
